(19) United States
(12) Patent Application Publication
(10) Pub. No.: US 2016/0063078 A1
(43) Pub. Date: Mar. 3, 2016

(54) AUTOMATIC IDENTIFICATION AND TRACKING OF LOG ENTRY SCHEMAS CHANGES

(71) Applicant: APOLLO EDUCATION GROUP, INC., Phoenix, AZ (US)

(72) Inventors: Yonghong Wang, Milpitas, CA (US); Pradeep Ragothaman, Sunnyvale, CA (US)

(21) Appl. No.: 14/473,378

(22) Filed: Aug. 29, 2014

(51) Int. Cl. G06F 17/30; H04L 29/08

(52) U.S. Cl. CPC G06F 17/30563; G06F 17/30292; H04L 67/10; G06F 17/30424

(57) ABSTRACT

A log analysis unit compares log entries describing an event to one or more schemas associated with the event. Each of the schemas describes a different log entry structure. When a log entry is determine to have a structure that does not match any of the structures defined by any of the schemas associated with a particular event, a new schema describing the structure of the log entry is generated. In response to the generation of the new schema, one or more entities are notified. Additionally, instructions for processing log entries adhering to the new schema are generated. A cumulative schema and an intersection schema corresponding to the event are also generated.

### TECHNICAL FIELD

The technical field relates to log data analysis, including the generation and tracking of schemas that describe the structure of log data and instructions for processing log data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

An application may generate log entries describing various events that occur in the application. Such log data may be used for a variety of purposes, such as to diagnose points of failure, maintain a history of events for subsequent retrieval, or to determine aggregate statistics regarding the various events that occur in the application. In some cases, log analysis software may process the log data to extract meaningful information relating to the various events that occurred in the application. In another case, the application itself may determine whether a certain event has occurred by reviewing the log data.

Certain occurrences may change the structure of the log entries generated by an application. For example, a developer of the application may modify application instructions that cause the log data to be generated. The modification to the application instructions may, for example, cause subsequent log entries to have different fields or different types of values in existing fields.

Even small changes to a schema may cause disruptions if not documented properly or if certain people remain unaware of the change. For example, log analysis software that processes the log data may no longer function properly if the log analysis software is only configured to process log entries that adhere to the previous log entry structure. Additionally, if new log analysis software ever needs to be generated subsequent to the schema change, it may be difficult for the developer of the log analysis software to ensure that the software is compatible with all the schemas to which previous log entries adhered. Approaches for alleviating or preventing difficulties caused by changes in the structure of log entries are needed.

### BRIEF DESCRIPTION OF THE DRAWINGS

In the drawings:

FIG. 1. illustrates an example system for the recovery and tracking of log entry schemas.

FIG. 2 illustrates an example process for the automatic identification and tracking of log entry schema changes

FIG. 3 illustrates different log entries that each describes different occurrences of the same event.

FIG. 4 illustrates excerpts of different example schemas that correspond to the same Faculty Dashboard View event.

FIG. 5 illustrates an example cumulative schema that describes each of the schemas corresponding to the Faculty Dashboard View event.

FIG. 6 illustrates an example computer system that may be specially configured to perform various techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods, stored instructions, and machines are provided herein for the automatic identification and tracking of changes in log entry schemas. In an embodiment, a log analysis unit compares log entries describing an event to one or more schemas associated with the event. Each of the schemas describes a different log entry structure. If a log entry is determined to have a structure that does not match any of the structures defined by any of the schemas associated with a particular event, a new schema describing the structure of the log entry is generated. In response to the generation of the new schema, one or more entities are notified. Additionally, instructions for processing log entries adhering to the new schema are generated.

In an embodiment, a cumulative schema is generated, which describes a union of each type of schema that is associated with a particular event. In an embodiment, an intersection schema is generated. An intersection schema describes only the fields that are common to each schema associated with a particular event.

The automatic generation of schemas may free individuals from having to manually generate documentation that describe schema changes since the automatically generated schemas may serve as such documentation. The automatically generated schemas may be generated more quickly than documentation that has to be created manually, particularly as the number of events and/or schema changes increase.

Furthermore, the automatically generated schemas may conform to the same consistent format, allowing for easier review than documentation generated manually, which may not adhere to a consistent format. A user may quickly and completely understand the structures of log entries over time by reviewing the various schemas that are generated or, in some cases, just the cumulative schema or the intersection schema. In some embodiments, a user or system may simply cause performance of the instructions that are generated without having to refer to any of the schemas.

### Example Schema Recovery and Tracking System

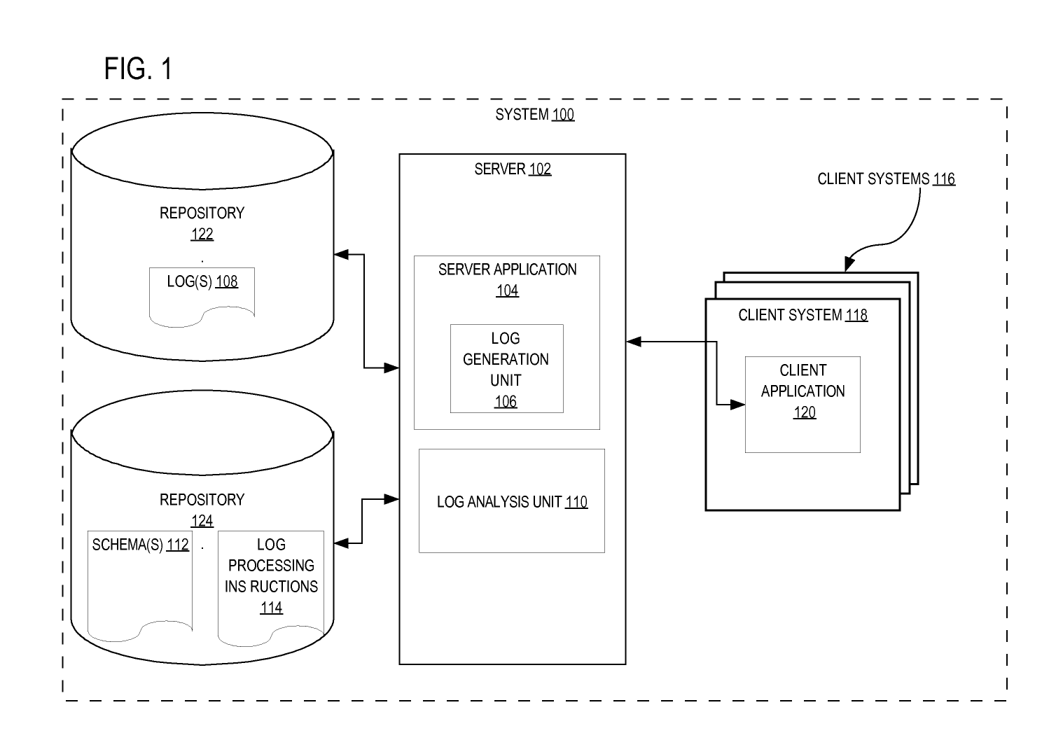

FIG. 1 illustrates an example system 100 for the recovery and tracking of log entry schemas. Client systems 116 are a plurality of computing devices used by different users to exchange information with server application 104 at server 102. For example, server application 104 may be an education application that communicates with various client applications including client application 120 at client system 118. Client application 120 may comprise instructions that cause a message to be sent to server application 104 every time any of a variety of application events occurs at client system 118. For example, client application 120 may notify server application 104 every time a user begins an assignment, requests to grade a quiz, or views an answer to a question using the application. Log generation unit 106 may create log entries in log(s) 108 identifying various events that occur in client application 120 and/or server application 104, the time at which they occur, and other information relating to the event.

Log analysis unit 110 analyzes various log entries in log(s) 108 and generates schema(s) 112, which describe the structure of various log entries in log(s) 108 over time. Schema(s) 112 may include individual schemas, cumulative schemas, and/or intersection schemas.

Log analysis unit 110 may also generate log processing instructions 114 which contain instructions for performing various operations on data in log(s) 108.

In an embodiment, for each of a plurality of events, repository 124 stores event information identifying the event in association with a one or more schemas identifying the structure(s) of log entries describing the event at various times, a cumulative or intersection schema corresponding to each of the one or more schemas associated with the event, and log processing instructions for processing log entries describing the event.

Log(s) 108 may be stored in repository 122 and schema(s) 122 and log processing instructions 114 may be stored in repository 124. Repository 122 and repository 124 may each be one or more different repositories or may be the same repository.

### Example Schema Recovery and Tracking Process

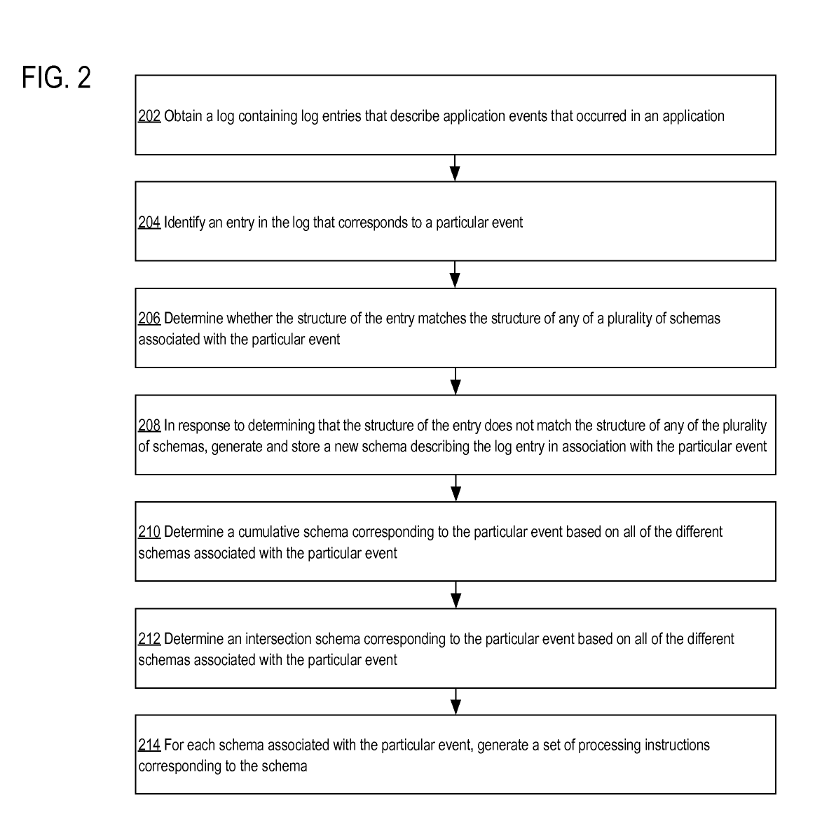

FIG. 2 illustrates an example process for the automatic identification and tracking of log entry schemas changes. The process of FIG. 2 may be performed at log analysis unit 110.

In step 202, log analysis unit 102 obtains a log containing log entries that describe application events that occurred in an application. In step 204, log analysis unit 102 identifies an entry in the log that corresponds to a particular event. Log analysis unit 102 may analyze log entries as they are generated or some time after they have been generated.

In step 206, log analysis unit 102 determines whether the structure of the entry matches the structures of any of a plurality of schemas associated with the particular event. The structure of log entries describing the particular event may be different at different times, and the plurality of schemas may describe each of the different structures detected by log analysis unit 102 in various logs describing the particular event.

In step 208, in response to determining that the structure of the entry does not match the structure of any of the plurality of schemas, log analysis unit 102 generates and stores a new schema describing the log entry in association with event information identifying the particular event.

In step 210, log analysis unit 102 determines a cumulative schema corresponding to the particular event based on all of the different schemas associated with the particular event. In step 212, log analysis unit 102 determines an intersection schema corresponding to the particular event based on all of the different schemas associated with the particular event. The cumulative and intersection schemas may be generated periodically or may be updated in response to the detection of each new schema.

In step 214, for each schema associated with the particular event, log analysis unit 102 generates a set of processing instructions corresponding to the schema. The processing instructions are for processing log entries that adhere to the corresponding schema.

According to various embodiments, one or more of the steps of the process illustrated in FIG. 2 may be removed or the ordering of the steps may be changed. For example, certain embodiments may only consist of determining a cumulative schema without determining an intersection schema, or the intersection schema may be determined before the cumulative schema.

### Example Log Entries

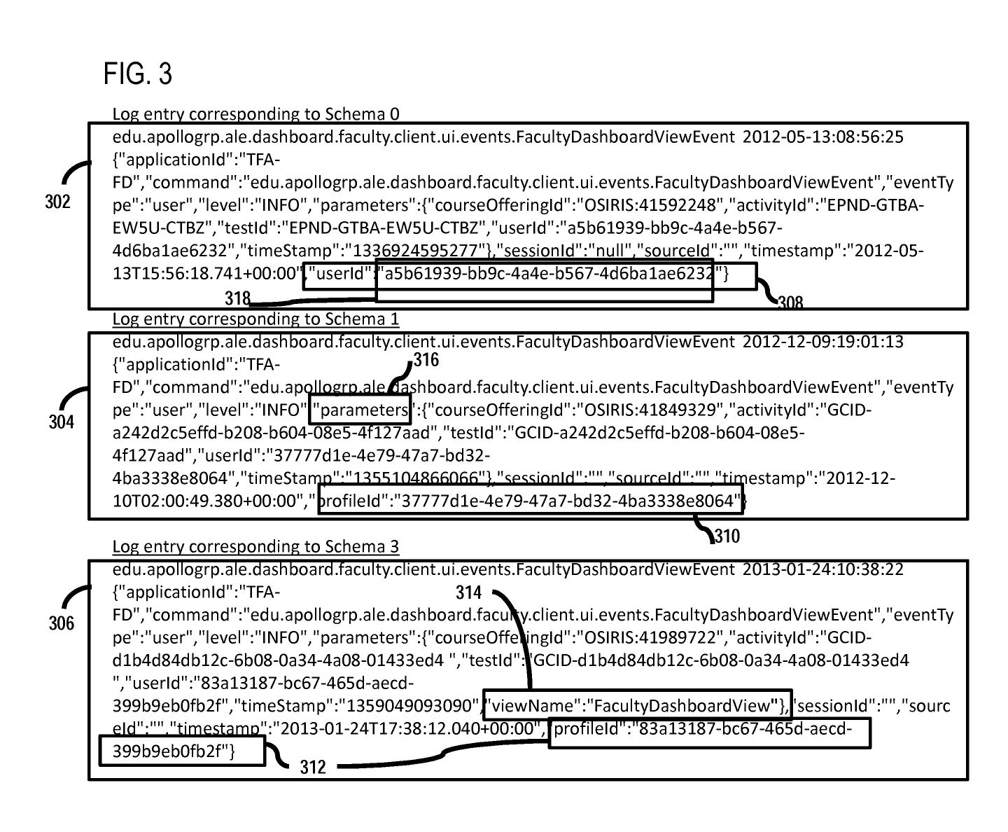

FIG. 3 illustrates different log entries that each describes different occurrences of the same event. Log entries 302, 304, and 306 each describe occurrences of a Faculty Dashboard View event, but each adhere to different schemas associated with the Faculty Dashboard View event. For example, some of the log entries include different fields. As indicated by text 308, the last field of log entry 302 is userId, whereas, as indicated by text 310 and 312, the last field of log entries 304 and 306 is profileId. Additionally, as indicated by text 314, log entry 306 identifies a new field of viewName, which is a sub-field of the parameters field identified by text 316 that does not exist in log entries 302 and 304.

Log entries 302, 304, and 306 include data conforming to the JavaScript Object Notation (JSON) representation. In other embodiments, log entry data may be represented in other formats including, but not limited, to Extensible Markup Language (XML) or HyperText Markup Language (HTML).

### Detecting Schema Changes

For every log entry analyzed, log analysis unit 110 may determine whether the log entry adheres to any of a set of stored schemas associated with the event described by the log entry. A log entry adheres to a schema if the structure of the log entry matches the structure described by the schema.

If the log entry does adhere to one of the existing schemas associated with the event, log analysis unit 110 does not generate a new schema. If the log entry does not adhere to any the schema(s) associated with the event or if no schemas are associated with the event, log analysis unit 110 may generate a schema describing the structure of the log event and store the generated schema in association with the event information identifying the event described by the log entry.

The amount and frequency of analysis by log analysis unit 110 may vary according to different embodiments. In one embodiment, log analysis unit 110 may sample portions of log(s) 108 on a periodic basis (e.g., every month). In another embodiment, log analysis unit 110 may analyze each log entry in log(s) 108 as it is generated or each log entry describing a particular event.

In some embodiments, log analysis unit 110 may analyze log data generated over a period of time to determine how frequently the schema changes for a particular event. Log analysis unit 110 and may select how frequently to sample log entries based on how frequently the schema for the particular event is determined to change. For example, log analysis unit 110 may determine that the schema for a Grade Quiz event changes, on average, every four weeks. Based on such a determination, log analysis unit 110 may analyze log data describing the Grade Quiz event once every three weeks.

Appendix A illustrates a plurality of schemas that may be generated by log analysis unit 110 based on log(s) 108. Appendix A includes different example schemas, Schemas 0, 1, and 2, which correspond to the same Faculty Dashboard View event.

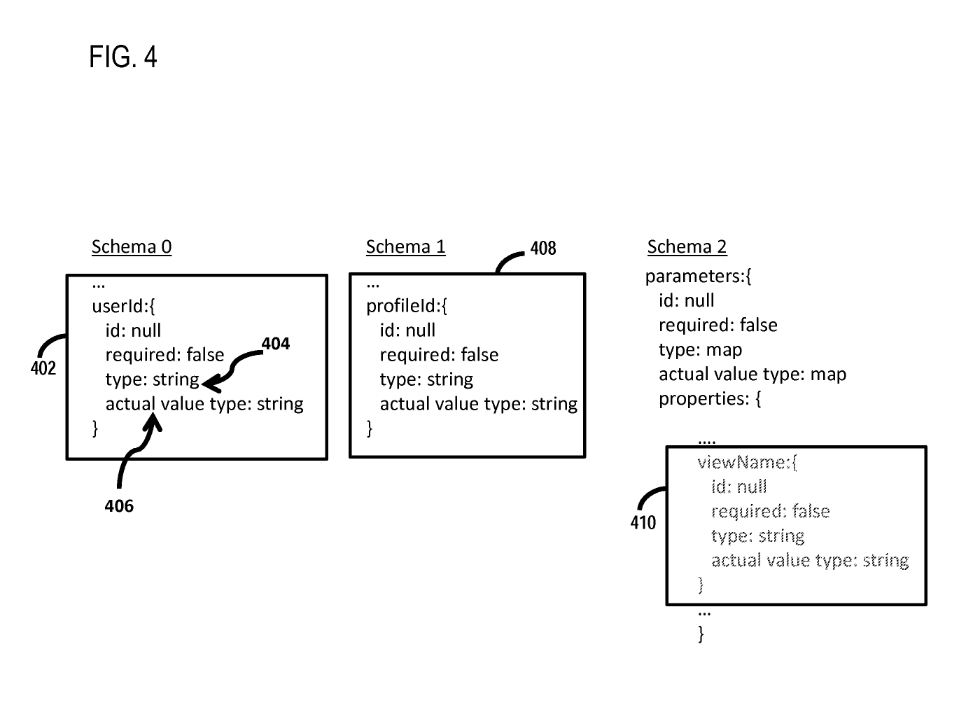

FIG. 4 illustrates excerpts of the different example schemas that correspond to the same Faculty Dashboard View event. Log analysis unit 110 may generate schema 0 the first time an entry describing a Faulty Dashboard View event is analyzed in log(s) 108, which may be, for example, log entry 302. The next time an entry describing a Faulty Dashboard View event is analyzed, log analysis unit 110 may compare the entry to schema 0. If the log entry adheres to schema 0, log analysis unit 110 may not generate any new schema. When a log entry is analyzed, which describes a Faulty Dashboard View event but does not adhere to schema 0, such as log entry 304, log analysis unit 110 may generate a new schema. For example, in response to analyzing log entry 304 and determining that log entry 304 does not adhere to the structure identified in schema 0, log analysis unit 110 may generate and store a new schema, schema 1, which describes the structure of log entry 304.

### Schema Change Notifications

Log analysis unit 110 may also notify one or more entities when a new schema is detected for a particular event. The notified entity may be an entity that uses log(s) 108, such as a user that develops software or other instructions that automatically process data in log(s) 108. In another embodiment, the user may review the log data manually. As a result of such a schema change notification, the user may take appropriate action, which may include making the necessary modifications to the software or other instructions being developed to ensure that the instructions are compatible with the new structure of the log data. In some situations, the user may contact a developer of client application 120 or server application 104, which caused the data in log(s) 108 to be generated and stored. The user may contact the developer to, for example, request a modification to the instructions that cause the generation of log data or to request an explanation for why a certain modification was made.

In another embodiment, the schema change notification may be sent to the developer of client application 120 or server application 104. In some cases, the schema corresponding to the particular event may have been modified unintentionally and, as a result of the notification, the developer may correct his or her error. In some embodiments, the schema change notification may request confirmation from the developer that the schema change occurred intentionally. Log analysis unit 110 may only store and retain a generated schema after a response is received from the developer indicating that the schema change was intentional. In another embodiment, log analysis unit 110 may store and retain the schema unless a response is received from the developer indicating that the schema change was unintentional. In response to receiving a response indicating that a schema change resulting in the generation of a particular schema was in error, log analysis unit 110 may remove an association between the particular schema and the corresponding event.

The schema change notification may describe the newly detected schema or may otherwise indicate how the schema has changed. The notification may be delivered to an account or device associated with the entity being notified. In an embodiment, log analysis unit 110 causes an e-mail message containing the notification to be sent to an e-mail address associated with the entity being notified.

One or more entities may subscribe to schema change notification by specifying certain events for which they are interested in receiving updates. In response to detecting a new schema for an event, log analysis unit 110 may automatically notify all entities that have subscribed to the event.

In some embodiments, a notification is sent each time a new schema is detected. In other embodiments, a notification is only sent for certain types of schema changes and not for others. For example, in an embodiment where a change of value type from one log entry to another constitutes a schema change warranting the generation of a new schema, the change in value type may not be a type of schema change that causes a schema change notification to be sent. In such an embodiment, notifications may only be sent for schema changes where a field is added or removed.

In an embodiment, the notification may include a request for a comments relating to the schema change. For example, if a new field is detected in certain log entries, log analysis unit 110 may request information relating to the new field, such as what the purpose of the new field is. In response, log analysis unit 110 may receive a comment including information relating to the new field and log analysis unit 110 may cause the comment to be stored in association with information identifying the new field in the generated schema. For example, log analysis unit 110 may send a notification to a developer who developed application 104 or 120 in response to detecting a log entry with a new “Birthplace” field. In response to receiving the notification, the developer may send a comment stating “This field is to include only the country of birth.” Log analysis unit 110 may store the comment in association with the “Birthplace” field of the corresponding schema.

### Example Schema Excerpts

As illustrated in the Appendix, Schema 0 includes an entry for each field that exists in the log entries that correspond to Schema 0. Referring to FIG. 4, entry 402 in Schema 0 corresponds to the userId field. As indicated by text 404, the base type of the userId field is String. As indicated by text 406, the actual type of the userId field is also String. In other embodiments, the base type and actual type of a particular field may be different.

Entry 408 In Schema 1 corresponds to the profileId field. Schema 1 includes an entry corresponding to the profileId field and does not include any entries corresponding to the userId field, because one or more log entries for the Faculty Dashboard View event may have indicated that the name of the userId field changed to profileId in at least some log entries. Log analysis unit 110 may have generated Schema 1 in response to determining that a log entry for the Faculty Dashboard View (e.g., log entry 304) event includes a profileId field and that the only schema corresponding to the Faculty Dashboard View event, Schema 0, does not describe a profile Id field. As a result, log analysis unit 110 may have generated and stored Schema 1, which includes entry 408 corresponding to the profileId field and does not include an entry corresponding to the userId field.

Entry 410 in Schema 2 corresponds to the viewName field. Log analysis unit 110 may have generated Schema 2 in response to determining that a log entry for the Faculty Dashboard View event (e.g., log entry 306) includes a viewName field and that each of the schemas corresponding to the Faculty Dashboard View event, Schemas 0 and 1, do not describe a viewName field. As a result, log analysis unit 110 may have generated and stored Schema 2, which includes entry 410 corresponding to the viewName field.

Although the schemas depicted in FIG. 4 identify, for each field, the actual and base types of values in that field, in other embodiments, a schema may only identify the base type of a field without identifying the actual type, or only the actual type of a field without identifying the base type, or may not specify the type of a field at all.

In some embodiments, a generated schema identifies the range of values associated with a particular field in the schema. For example, a schema may indicate that in all analyzed log entries corresponding to a particular event, values corresponding to the “age” field are between 18 and 55. For a field associated with a Boolean value, the schema may indicate whether the field has always included values of one type (e.g. True or False).

For fields associated with a numerical type, such as Int or Float, the schema may indicate what the maximum and/or minimum value associated with the field is. The schema may also indicate what the maximum, minimum, or range of value length for a particular field is, or if the value is empty (e.g., NULL).

A schema may also indicate the times at which log entries adhering to the schema were generated. For example, in response to determining that a particular log entry adheres to a particular schema, log analysis unit 110 may determine whether a timestamp that appears in the log entry is within the range(s) of time identified in the particular schema. If not, log analysis unit 110 may update the range(s) of time to include the time identified in the timestamp. Such an approach will allow a user who is reviewing a schema to quickly determine the general timeframe of when that schema was applicable and whether it is currently applicable.

### Base Types and Actual Types

In certain embodiments, the actual type of a particular field may be different than the base type of the particular field. The base type of a field may be determined by determining if the value in the field conforms to any of a set of base types (e.g. Int and String). The actual type of a field may be determined by determining if the value in the field conforms to any of a set of sub-types of the determined base type. For example, a base type of String may have sub-types of Empty, List of Integers, List of String, Long, Date, and others.

To illustrate a clear example, log analysis unit 110 may compare a value of “08/17/2014” to a set of base types such as Int and String and may determine that the value has a base type of String because the value contains both numerical elements and character elements. Log analysis unit 110 may compare the same value to definitions of different sub-types of the String type and may determine that the actual type of the value is Date because of the format of the text in the value (specifically, that the value consists of two numerical elements, followed by a slash, followed by two numerical elements, followed by slash, and followed by four numerical elements).

As another example, log analysis unit 110 may compare a value of “[1,2,3]” to a set of base types such as Int and String and may determine that the value has a base type of String because the value contains both numerical elements and character elements. Log analysis unit 110 may compare the same value to definitions of different sub-types of the String type and may determine that the actual type of the value is List of Integers because of the format and type of the elements in the value (specifically, that the value consists of integers delimited by commas and enclosed in square braces).

Actual types may also have sub-types which log analysis unit 110 determines and identifies in a schema. For example, if log analysis unit 110 determines that a value is of a “composite” type (i.e. a type that contains of one or more entities of another or the same type), such as an array or a list, log analysis unit 110 may also determine the type of elements in the composite type.

For every value that is determined to be of composite type (e.g., list or array), log analysis unit 110 log analysis unit 110 may parse the value to determine the type of the individual elements that make up the value. If the value is a composite type that itself consists of one or more other composite types (e.g., a list of lists or an array of lists), log analysis unit 110 may continue parsing the nested composite types until an atomic type is detected (e.g., a list or char).

To illustrate a clear example, a certain value in a log entry may be a list of lists, where the nested lists are each list of date values. Log analysis unit 110 may determine that the base type of the value is String. In addition, log analysis unit 110 may parse each of the lists to determine that the actual type of the value is a list of lists, where the nested lists contain values of type “Date.” As a result, log analysis unit 110 may generate a schema that states “Base type: String” and “Actual type: List <List <Date>>>.”

### Shallow and Deep Comparisons

When determining whether a log entry adheres to a particular schema, log analysis unit 110 may perform either a “shallow” comparison between the schema and the log entry or a “deep” comparison. When performing a shallow comparison, log analysis unit 110 compares only the field names in the log entry to the field names in the schema. In a shallow comparison, a log entry is determined to adhere to the schema if, for every field identified in the schema, the field exists in the log entry and no additional fields exist in the log entry. When performing a deep comparison, log analysis unit 110 also examines the values for each field in the log entry. In a deep comparison, a log entry is considered to adhere to the schema if, for every field identified in the schema, the type of the value of the corresponding field in the log entry adheres to the type identified in the schema for the field. When comparing a log entry to one or more schemas, a log entry may be considered as not adhering to a particular schema if the value of a field in a log entry is of a type different than the type identified as the “actual” type in the particular schema.

For example, when performing a shallow comparison of a log entry for the FacutlyDashboardView event to Schema 0, log analysis unit 110 may determine that the log entry adheres to the Schema 0 even if the value for the userId field in the log entry is of type Int and Schema 0 describes the value for the userId field as being of type String. In contrast, when performing a deep comparison of the same log entry to Schema 0, log analysis unit 110 may conclude that the log entry does not adhere to Schema 0 because the value for the userId field in the log entry is of type Int, which is different than the type identified in Schema 0 for the userId field.

In some embodiments, when comparing a log entry to a schema, the length of a value in a particular field of the log entry is compared to a length identified in the schema. If the length of a value in the particular field of a log entry is different than the length identified in the schema, log analysis unit 110 may consider the log entry as adhering to a new schema and, as a result, may generate and store the new schema.

A user, such as a developer that uses the schemas generated by log analysis unit 110, may specify what types of differences constitute a schema change. Log analysis unit 110 may perform comparisons between log entries and schemas based on the user specification. For example, a user may specify that, for a particular event, the addition or removal of a field is to constitute a schema change but that the change in value type or value length is not to constitute a schema change. Based on such a user specification, log analysis unit 110 may perform only a shallow comparison when analyzing log entries corresponding to the particular event.

### Cumulative and Intersection Schemas

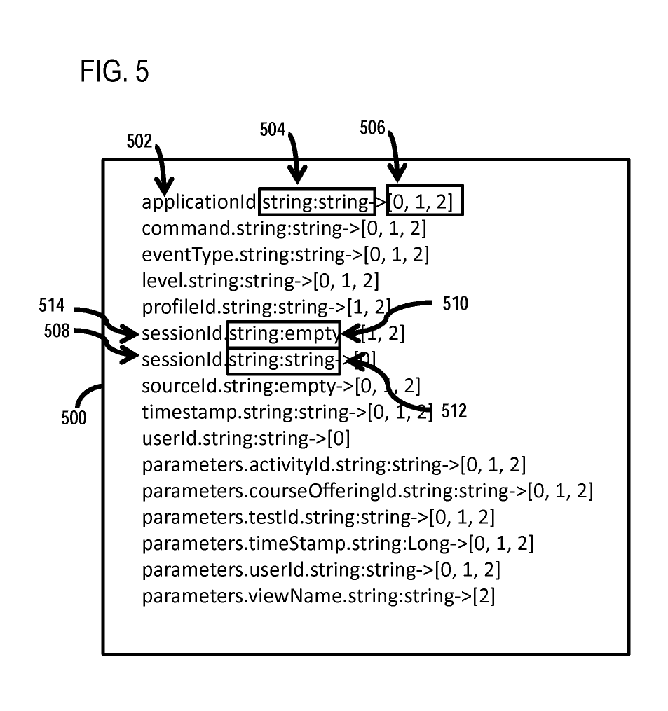

In an embodiment, log analysis unit 110 generates a cumulative schema that describes a union of each type of schema that is associated with a particular event. FIG. 5 illustrates an example cumulative schema that describes each of the schemas corresponding to the Faculty Dashboard View event, schema 0, schema 1, and schema 3. All log entries in log(s) 108 describing the particular event may adhere to one of the three schemas identified in the cumulative schema.

Cumulative schema 500 includes an entry for each field name that exists in each of the schemas associated with the Faculty Dashboard View event. For example, entry 502 corresponds to the field of applicationId. In some embodiments, the schema indicates what the base type of a field is and what the actual type of a field is. For example, the values 504 of “string:string” following field name of “applicationId” in entry 502 indicate that in schemas 0, 1, and 2, the base type of the applicationId field is String and the actual type is also String. Values 506 in entry 502 indicate that entry 502 is applicable to schemas 0, 1, and 2.

For fields that have different actual types in different schemas, cumulative schema 500 contains a separate entry for each actual type corresponding to the field name. For example, sessionId field name has an actual type of String in Schema 0 and an actual type of Empty in Schemas 1 and 2. As a result, two entries, entries 514 and 508, were generated for the sessionId field in cumulative schema 500. Text 510 in entry 514 indicates that, in each of the log entries corresponding to schemas 1 and 2, the base type of the sessionId field is String and the actual type of the sessionId field is Empty. Text 512 in entry 508 indicates that, in each of the log entries corresponding to schema 0, the base type of the sessionId field is String and the actual type of the sessionId field is also String.

In another embodiment, where schemas are generated for the Faculty Dashboard View event using only a shallow comparison, there may be only one entry for the sessionId field in the cumulative scheme, and the single entry may correspond to all three of schemas 0, 1, and 2. The existence of one entry that corresponds to all three schemas indicates that a schema change was not detected for the sessionId field across all the log entries that adhere to schemas 0, 1, and 2 when performing a shallow comparison. That is because the only difference between schema 0 and schemas 1 and 2 with respect to the sessionId field is that the actual type of the sessionId field in schemas 1 and 2 is different than in schema 0, and certain types of shallow comparisons do not compare the actual types of different fields.

In an embodiment, log analysis unit 110 generates an intersection schema that describes fields that are common to each type of schema that is associated with a particular event and only such fields. For example, an intersection schema may include an entry for each field that exists each of the schemas associated with the Faculty Dashboard View event, and only such fields. For example, if a particular field is only present in some log entries that describe the Faculty Dashboard View event and not in other log entries that describe the same event, the particular field may not be described in the intersection schema. Similarly, the intersection schema may not describe fields for which field names change across different log entries.

In some embodiments where schemas are generated using shallow comparison, an intersection schema for a particular event may include a log entry corresponding to a field even though the field is associated with different actual value types in different log entries. That is, the field name may be associated with different actual types in different schemas associated with the particular event. In other embodiments, for a field to be described in the intersection schema, the actual type corresponding to the field must be the same for all schemas corresponding to the particular event.

In some embodiments, a cumulative or intersection schema describes multiple events and not just a single event. In an embodiment, a cumulative or intersection schema describes a set of events that frequently occur together. For example, a sequence of events may occur between the time a user initiates and a quiz and completes a quiz and each of the events in the sequence may be described in a cumulative or intersection schema. In another embodiment, an administrator or some other user specifies events to be described by a particular cumulative or intersection schema.

### Updating and Use of Cumulative and Intersection Schemas

A cumulative and/or an intersection schema for a particular event may be updated every time a new schema is detected for a particular event. A user that develops software that refers to data in log(s) 108 may determine how to design his or her software or instructions by evaluating the cumulative schema. By ensuring that the instructions he or she develops are compatible with all log entries that conform to any one of the schemas in the cumulative schema, the developer may be sure that his or her instructions will be compatible with the generated log data as long as the log data continues to conform to one of the previously used schemas.

An intersection schema may also be useful to such a user. For example, by identifying a particular field in an intersection schema, a developer may infer that the particular field exists in all log entries corresponding to the particular event. Based on that determination, the developer may design software that utilizes the value in the particular field with some level of assurance that the particular field will continue to be present in future log entries that correspond to the particular event.

As another example, an intersection schema may also be useful to a user who wants to quickly determine if the value type for a particular field ever changed across log entries or if the particular field is present in all log entries corresponding to each of the schemas. The user may quickly do so by searching for an entry in the intersection schema corresponding to the particular field. In an embodiment, if an entry corresponding to the particular field exists in the intersection schema, the entity may infer that value type of the particular field has never changed in any of the log entries analyzed. The user, as used herein, may be a computer or a human.

### Generation of Instructions for Processing Log Entries

After a schema is generated, log analysis unit 110 may automatically generate and store instructions for processing log entries corresponding to the schema. The operations performed by the log processing instructions may vary according to different embodiments. In one embodiment, the log processing instructions are configured to parse log entries whose structure adheres to the corresponding schema and extract information from such log entries.

In an embodiment, a single event is associated with different schemas, and log processing instructions associated with each of the different schemas extract information using a different technique but provide the information in a uniform format. Examples of different techniques include extracting information from different fields and converting things from different formats.

To illustrate a clear example, in one embodiment, a particular event causes a log entry specifying a person's full name to be generated. The particular event is associated with different schemas describing the different structures of log entries that are generated by the particular event. Each of the different schemas specifies a different structure for storing the full name. For example, in log entries adhering to a first schema, a full name may be stored across three different fields (e.g., a First Name field, a Middle Name field, and a Last Name field). Log entries adhering to a second schema may only include a single Name field. Log entries adhering to a third schema may include a single FullName field, where the name of the field is different than the name used in the second schema. The log processing instructions associated with the first schema, second schema, and third schema may each extract information differently when executed. That is, the log processing instructions associated with the first schema may access values in each of the First Name field, Middle Name field, and Last Name field. Log processing instructions associated with the second schema may only access the single Name field and log processing instructions associated with the third schema may only access the single FullName field. Nevertheless, all three log processing instructions may output the name information in the same format (e.g. the name may be provided in single String value). Such an approach allows a user to rely on the fact that all instructions associated with each of the schemas for an event will provide information in a consistent format, regardless of how the information is stored according to the different schemas. This may be useful in a situation where, for example, a user develops software or other instructions that accept the output of the log processing instructions as an input. In such a situation, software can be programmed to expect input in the same consistent format from the log processing instructions, regardless of which schema the log processing instructions are associated with.

In some embodiments, a user may specify the operations to be performed by the log processing instructions. For example, a user may request that the log processing instructions determine the number of userIDs included in a log entry. Based on the user request, in response to generating and storing a new schema, log analysis unit 110 may automatically generate and store, in association with the new schema, instructions for determining the number of userIDs in log entries corresponding to the schema.

Log processing instructions may be associated with a cumulative schema and may be configured to process log entries whose structure adheres to any of the schemas described by the cumulative schema. Separate log processing instructions may also or instead be associated with an intersection schema and may be configured to process fields of log entries that are common to all schemas associate with an event.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

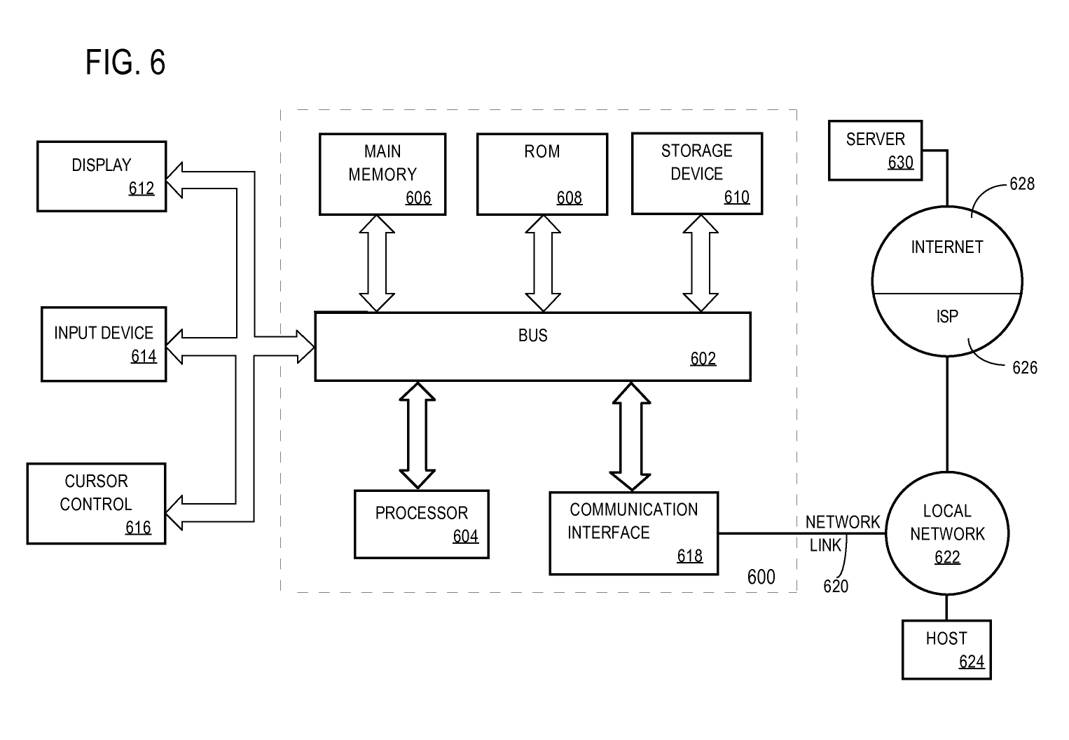

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a light emitting diode (LED) display, for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Appendix

Below are example schemas that each corresponds to the same event. The below schemas may be generated by analyzing one or more log entries describing different occurrences of the same event.

What is claimed is:

1. A method comprising:
obtaining a first log entry in a log, wherein the first log entry describes a first occurrence of a particular event;
wherein data within the first log entry is organized according to a first structure;
in the absence of any schema that accurately describes the first structure, generating, based on the first log entry, a first schema describing the first structure;
storing the first schema;
obtaining a second log entry in the log, wherein the second log entry describes a second occurrence of the particular event;
wherein data within the second log entry is organized according to a second structure;
determining that the second structure does not match the first structure;
in response to determining that the second structure does not match the first structure, generating, based on the second log entry, a second schema describing the second structure;
storing the second schema;
generating, based on a plurality of schemas for the particular event, a cumulative schema corresponding to the particular event;
wherein the plurality of schemas includes at least the first schema and the second schema;
wherein the cumulative schema describes each field of each of the plurality of schemas; and
wherein the method is performed by one or more computing devices.

2. The method of claim 1 further comprising:
generating, based on the plurality of schemas, an intersection schema describing only those fields that are common to every schema in the plurality of schemas.

3. The method of claim 1, wherein:
the step of determining that the second structure does not match the first structure includes determining that a value in a particular field of the second log entry is of a different type than a type identified in the first schema for the particular field.

4. The method of claim 1, wherein:
the step of determining that the second structure does not match the first structure includes determining that a value in a particular field of the second log entry is of a different length than a length identified in the first schema for the particular field.

5. The method of claim 1, wherein:
the cumulative schema identifies a plurality of fields of the plurality of schemas; and
for at least one field of the plurality of fields, the cumulative schema identifies:
a base type of the at least one field; and
an actual type of the at least one field.

6. The method of claim 5, wherein the base type is different than the actual type.

7. The method of claim 1 further comprising:
in response to determining that the second log entry does not conform to the first schema, notifying a particular entity associated with development of an application that caused the log to be generated.

8. The method of claim 1 further comprising:
wherein the step of notifying the particular entity includes sending a notification identifying a schema change relating to a particular field in a particular schema and that requests comments regarding the schema change;
receiving a comment relating to the schema change;
storing the comment in association with the particular field in the particular schema.

9. The method of claim 1 further comprising:
in response to determining that the second log entry does not conform to the first schema, notifying a particular entity that uses data in the log.

10. A method comprising:
obtaining a log entry in a log, wherein the log entry describes an occurrence of a particular event;
wherein data within the log entry is organized according to a particular structure;
determining that a base type of a value in a particular field in the log entry is a first type;
based on an analysis of the value, determining that the value has an actual type of a second type that is different than the first type;
in the absence of any schema that accurately describes the particular structure, generating, based on the log entry, a schema describing the particular structure;
wherein the schema indicates that the base type of the value in the particular field is the first type, and that an actual type of the value in the particular field is the second type;
storing the schema; and
wherein the method is performed by one or more computing devices.

11. The method of claim 10 further comprising:
obtaining a second log entry in the log, wherein the second log entry describes a second occurrence of the particular event;
determining that the second log entry does not conform to the schema based on a determination that, within the second log entry, the particular field has a particular value that is of a different type than the second type;
in response to determining that the second log entry does not conform to the schema:
generating, based on the second log entry, a second schema describing a structure of the second log entry; and
sending a notification to an entity indicating that a schema change has occurred.

12. A method comprising:
obtaining a first log entry in a log, wherein the first log entry describes a first occurrence of a particular event;
wherein data within the first log entry is organized according to a first structure;
in the absence of any schema that accurately describes the first structure, generating, based on the first log entry, a first schema describing the first structure;
storing the first schema;
determining a first set of log entry processing instructions, which when executed, automatically extract data from log entries adhering to the first structure;
obtaining a second log entry in the log, wherein the second log entry describes a second occurrence of the particular event;
wherein data within the second log entry is organized according to a second structure;
determining that the second structure does not match the first structure;
in response to determining that the second structure does not match the first structure:
generating, based on the second log entry, a second schema describing the second structure;
storing the second schema;
determining a second set of log entry processing instructions, which when executed, automatically extract data from log entries adhering to the second structure;
associating the second set of log entry processing instructions with the second schema; and
wherein the method is performed by one or more computing devices.

13. The method of claim 12, wherein the first set of log entry processing instructions and the second set of log entry processing instructions extract data using different techniques but both the first set of log entry processing instructions and the second set of log entry processing instructions provide information in a same format.

14. One or more non-transitory computer-readable media storing instructions which, when executed by one or more processors, cause performance of a method comprising:
obtaining a first log entry in a log, wherein the first log entry describes a first occurrence of a particular event;
wherein data within the first log entry is organized according to a first structure;
in the absence of any schema that accurately describes the first structure, generating, based on the first log entry, a first schema describing the first structure;
storing the first schema;
obtaining a second log entry in the log, wherein the second log entry describes a second occurrence of the particular event;
wherein data within the second log entry is organized according to a second structure;
determining that the second structure does not match the first structure;
in response to determining that the second structure does not match the first structure, generating, based on the second log entry, a second schema describing the second structure;
storing the second schema;
generating, based on a plurality of schemas for the particular event, a cumulative schema corresponding to the particular event;
wherein the plurality of schemas includes at least the first schema and the second schema;
wherein the cumulative schema describes each field of each of the plurality of schemas.

15. The one or more non-transitory computer-readable media of claim 14, wherein the method further comprises:
generating, based on the plurality of schemas, an intersection schema describing only those fields that are common to every schema in the plurality of schemas.

16. The one or more non-transitory computer-readable media of claim 14, wherein:
the step of determining that the second structure does not match the first structure includes determining that a value in a particular field of the second log entry is of a different type than a type identified in the first schema for the particular field.

17. The one or more non-transitory computer-readable media of claim 14, wherein:
the step of determining that the second structure does not match the first structure includes determining that a value in a particular field of the second log entry is of a different length than a length identified in the first schema for the particular field.

18. The one or more non-transitory computer-readable media of claim 14, wherein:
the cumulative schema identifies a plurality of fields of the plurality of schemas; and
for at least one field of the plurality of fields, the cumulative schema identifies:
a base type of the at least one field; and
an actual type of the at least one field.

19. The one or more non-transitory computer-readable media of claim 18, wherein the base type is different than the actual type.

20. The one or more non-transitory computer-readable media of claim 14, wherein the method further comprises:
in response to determining that the second log entry does not conform to the first schema, notifying a particular entity associated with development of an application that caused the log to be generated.

21. The one or more non-transitory computer-readable media of claim 14, wherein the method further comprises:
wherein the step of notifying the particular entity includes sending a notification identifying a schema change relating to a particular field in a particular schema and that requests comments regarding the schema change;
receiving a comment relating to the schema change;
storing the comment in association with the particular field in the particular schema.

22. The one or more non-transitory computer-readable media of claim 14, wherein the method further comprises:
in response to determining that the second log entry does not conform to the first schema, notifying a particular entity that uses data in the log.

23. One or more non-transitory computer-readable media storing instructions which, when executed by one or more processors, cause performance of a method comprising:
obtaining a log entry in a log, wherein the log entry describes an occurrence of a particular event;
wherein data within the log entry is organized according to a particular structure;
determining that a base type of a value in a particular field in the log entry is a first type;
based on an analysis of the value, determining that the value has an actual type of a second type that is different than the first type;
in the absence of any schema that accurately describes the particular structure, generating, based on the log entry, a schema describing the particular structure;
wherein the schema indicates that the base type of the value in the particular field is the first type, and that an actual type of the value in the particular field is the second type;
storing the schema.

24. The one or more non-transitory computer-readable media of claim 23, wherein the method further comprises:
obtaining a second log entry in the log, wherein the second log entry describes a second occurrence of the particular event;
determining that the second log entry does not conform to the schema based on a determination that, within the second log entry, the particular field has a particular value that is of a different type than the second type;
in response to determining that the second log entry does not conform to the schema:
generating, based on the second log entry, a second schema describing a structure of the second log entry; and
sending a notification to an entity indicating that a schema change has occurred.

25. One or more non-transitory computer-readable media storing instructions which, when executed by one or more processors, cause performance of a method comprising:
obtaining a first log entry in a log, wherein the first log entry describes a first occurrence of a particular event;
wherein data within the first log entry is organized according to a first structure;
in the absence of any schema that accurately describes the first structure, generating, based on the first log entry, a first schema describing the first structure;
storing the first schema;
determining a first set of log entry processing instructions, which when executed, automatically extract data from log entries adhering to the first structure;
obtaining a second log entry in the log, wherein the second log entry describes a second occurrence of the particular event;
wherein data within the second log entry is organized according to a second structure;
determining that the second structure does not match the first structure;
in response to determining that the second structure does not match the first structure:
generating, based on the second log entry, a second schema describing the second structure;
storing the second schema;
determining a second set of log entry processing instructions, which when executed, automatically extract data from log entries adhering to the second structure;
associating the second set of log entry processing instructions with the second schema.

26. The one or more non-transitory computer-readable media of claim 25, wherein the first set of log entry processing instructions and the second set of log entry processing instructions extract data using different techniques but both the first set of log entry processing instructions and the second set of log entry processing instructions provide information in a same format.
